(19) United States
(12) Patent Application Publication
(10) Pub. No.: US 2019/0271963 A1
(43) Pub. Date: Sep. 5, 2019

(54) Multi-Site Production System And Method

(71) Applicants: REVATIS SA, Liège (BE); SALAMANDER U, Haillot (BE)

(72) Inventors: Claude DEDRY, Archennes (BE); Tony DONOLATO, Haillot (BE); Philippe NEYT, Haillot (BE); Denis DECUBBER, Flobecq (BE); Didier SERTEYN, Liege (BE); Justine CEUSTERS, Kemexhe (BE)

(21) Appl. No.: 16/344,730

(22) PCT Filed: Oct. 24, 2017
(86) PCT No.: PCT/EP2017/077202

§ 371 Date: Apr. 24, 2019

(30) Foreign Application Priority Data
Oct. 25, 2016 (BE) 2016/5805

(51) Int. Cl. G05B 19/406; G06Q 50/04; G06Q 30/00

(52) U.S. Cl. CPC G05B 19/406; G10L 15/22; G06Q 30/018; G06Q 50/04

(57) ABSTRACT

The invention relates to a multi-site production system for production of a product under regulated conditions comprising at least two production sites (12) linked to a central monitoring unit (10), each production site (12) comprising at least one production unit (16) for production under regulated conditions and a computerized control unit (14) designed to receive, possibly record, and transfer required product and/or process parameters to the central monitoring unit (10) designed to check for validation purposes the production process and/or product quality. The invention further relates to a method for multi-site production under regulated conditions making use of above system.

The present invention relates to a multi-site production system for production and data recording under regulated conditions, such as GMP or other strictly regulated conditions, in order to ensure constant and uniform product quality in line with relevant regulation requirements. The invention further relates to a method, more particularly a computer-implemented method, for multi-site production under regulated conditions.

Certain products, like certain chemicals, food products, pharmaceutical products, biological products, medical devices, need to be manufactured in conformity with guidelines imposed or recommended by states or state/regulatory agencies that control the authorizations for manufacturing and sale of said products. As an example, Good Manufacturing Practice (GMP) guidelines provide guidance for manufacturing, testing and quality assurance in order to ensure that the relevant product is safe for consumption and/or use. Reference is made for instance to https://en.wikipedia.org/wiki/Good_manufacturing_practice.

The terms “production under regulated conditions” are used herein to designate production of mostly regulated products in accordance with laws, regulations or guidelines recommended to ensure high quality products that do not pose any risk to the consumer or public. Such guidelines may be internal to the manufacturer or imposed by regulatory bodies.

Also, despite the fact that industrial production is ever more automated, certain particular production processes still need to be performed by human operators. This is the case for instance in the textile industry, electronics industry, certain food and/or feed productions and in productions of biological or pharmaceutical products, cellular therapies or gene modifications and/or gene therapies, as well as in clean room production units.

Some of these production processes need to be performed under aseptic conditions, in accordance with strict standards or guidelines under permanent quality control procedures. To that effect, a certain number of parameters need to be measured and recorded in the course of the production process.

In order to meet today's high quality standards, a product must show the required specified quality over the whole of its production, whenever and wherever it is produced.

In addition, particularly in the case of biological products, like cells, DNA etc, conservation or storage time is an important aspect of the product quality as storage generally affects product quality. Also, transport and/or handling operations may affect the product quality. For all these reasons, such products need to be produced geographically close to the consumer. The multiplication of production sites, however, is likely to affect uniform and consistent product quality which becomes particularly difficult to control and such control requires additional time consuming and sometimes quality affecting and expensive control processes.

The present invention now seeks to overcome these difficulties. More specifically, the invention seeks to provide a production system that ensures constant and uniform product quality in line with regulated requirements, wherever the product has been produced.

The invention provides a multi-site production system comprising at least two production sites linked to a central monitoring unit, each production site comprising at least one production unit for production under regulated conditions and a computerized control unit designed to receive, optionally record, and transfer required product and/or process parameters to the central monitoring unit designed to check for validation purposes the production process and/or product quality.

The invention production system allows for production of a (regulated) product at different sites, thereby ensuring a common, constant and uniform quality managed from a single central unit. It further allows production close to the consumer, hence reduction of storage, transport and handling operations, and supply of fresh product.

As will be understood by the person skilled in the art, the central monitoring unit may consist in a computerized monitoring unit designed to receive required product and/or process parameters from the computerized site based control units and to compare the relevant product and/or process parameters to established standards and/or rules. It may also be designed to store and send pre-established instructions to the production sites, preferably through the on-site control units.

The computerized central monitoring unit may be designed to display the results of the comparison and possibly even to propose validation decisions which will finally be taken centrally.

The production sites of the multi-site production system of the invention advantageously comprises computer assisted production units. Preferred embodiments of such computer assisted production units will be described herein below.

According to a preferred embodiment, the production site comprises (i) at least one production unit which may operate under clean room conditions and which is operated by at least one human operator, and (ii) a computerized operator or control unit designed (i) to give instructions in accordance with a predetermined possibly multistep manufacturing procedure to the human operator, (ii) to possibly receive an oral report by the human operator on the performance of the relevant steps of the manufacturing procedure and (iii) to control the performance of the relevant steps of the manufacturing procedure and predetermined quality parameters of the resulting product. To that effect, the computerized control unit receives process operating instructions from the central monitoring unit and/or comprises instruction storage means and an interface for communicating bi-directionally with the human operator. Advantageously, the communication interface of the control unit comprises a voice recognition module designed to receive oral reports from the human operator. It may further comprise a voice synthesis module designed to instruct and/or inform the human operator.

State of the art production systems for regulated productions as defined in the introductory part require the presence of at least two human operators. At least one human operator gives instructions and records process parameters and at least one human operator performs the manual operating steps. The wearing of protective clothes and equipment is required and it will be easily understood that the operator performing the manual tasks with his hands in protective gloves may not simultaneously manipulate paper sheets, computer keyboards etc. After relevant process steps have been carried out, the recorded parameters are checked prior to validation of the product quality. In short, a second operator is indispensable in order to free the hands of the operator executing manual operating steps as well as to perform a double check of the operating steps performed by the colleague. It is clear that such production units contribute to high production costs. Moreover, a production cycle often needs to be carried out in its entirety before a reliable quality control can be performed, even if a mismatch has occurred at early production steps. Finally also, the error margin due to the subjectivity of the human operators taking decisions in the course of their performance of tasks cannot be ignored, and introduces high variability in product quality, more particularly between different human operators.

In contrast, the invention production system requires solely at least one human operator for performance of the manual operations within the production steps of the production process. The human operator communicates with the control unit which in turn communicates bi-directionally with the central monitoring unit. The instructions to the human manual operator are produced by the control unit or, in the alternative, by the central monitoring unit through the control unit, e.g. on a screen or through a voice synthesis module. The control unit then also measures the relevant parameters and possibly saves the results in its memories or storage means. The control unit is designed to communicate relevant parameters to the central monitoring unit, which finally checks for validation purposes the relevant production from a single central location. Variability of results due to human intervention is hence significantly minimized. In addition, as final validation is made centrally, variability due to multi-site production is avoided. Production costs are reduced as a result of high level automation.

The term “link” or “linked” as used herein is understood to mean a connection materialized by a cable or a connection through electromagnetic waves or via the World Wide Web allowing for data transfer, preferably in both directions.

As stated, the production unit should be arranged to be operable under regulated conditions. According to a preferred embodiment, the production unit comprises at least one isolator, advantageously arranged in a clean room in which operates at least one human operator. The term “isolator” as used herein is to be understood as an isolator, glove box or containment system as used in the pharmaceutical industry.

The present invention then also relates to a method, more specifically a computer-implemented method, for multi-site production under regulated conditions comprising production of a product under regulated conditions at at least two production sites in respective production units wherein said production is controlled by a computerized control unit designed to receive, possibly record and transfer required product and/or process parameters to a central monitoring unit located at another site, and wherein the central monitoring unit checks for validation purposes the production process and/or product quality.

The control unit may be designed to receive from the central monitoring unit the relevant process operating instructions to be transmitted to the human operator, and/or may be designed to store such instructions for transmission to the human operator.

The invention method finally consists in operating the invention multi-site production system described above.

The invention is described in more details herein below with reference to the accompanying drawings, wherein:

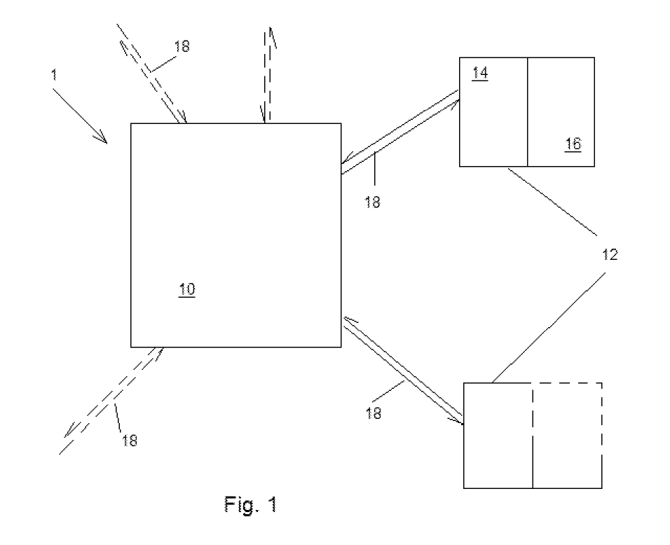

FIG. 1 is a schematic representation of a production system of the invention;

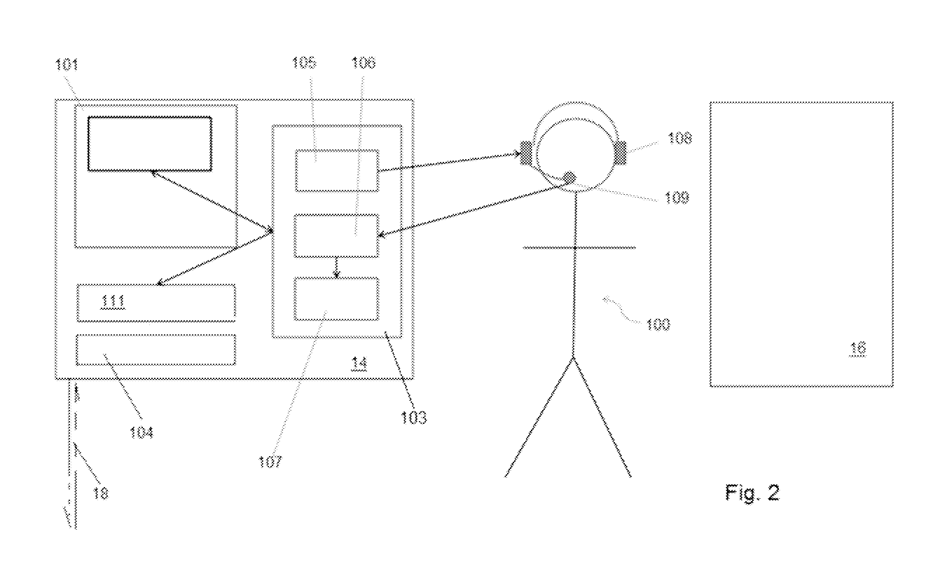

FIG. 2 is a schematic representation of a decentralized production unit

The invention production system 1 comprises a central monitoring system 10 and a plurality of production sites 12 at different distant locations. The production sites 12 each comprise a production unit 14 associated with a decentralized control unit 16. The production unit 14 is designed for production under regulated conditions. Each production site is linked to the central monitoring unit 10, preferably by way of connecting means 18 allowing for bi-directional communication or data exchange between the control unit 16 and the central monitoring unit. The decentralized control unit 16 further is designed to receive, optionally record, and transfer required product and/or process parameters to the central monitoring unit 10 which is a computerized monitoring unit designed to receive required product and/or process parameters from the computerized site based control units 16 and to compare the relevant product and/or process parameters to established standards and/or rules and possibly to validate the production process and/or product quality. Validation decision may also be taken by a human operator at the central monitoring unit, acting for all decentralized production units. Validation decisions are advantageously transferred to the relevant decentralized control units.

In certain embodiments, the instructions to be transmitted to the human operator are stored in the central monitoring unit designed to transmit same to the production sites through the on-site control unit to the human operator. This system may be favored in order to ensure that operating instructions are consistent through all sites, may not be amended on site and may only be amended centrally.

As explained above, the connecting means 18 may consist in an electrical connection materialized by a cable or a connection via electromagnetic waves or the World Wide Web. The skilled person will be able to select without undue burden the most appropriate connection on the basis of his or her experience and skills and depending on the requirements placed on the production system and on the production itself.

The computerized central monitoring unit 10 may be designed to display the results of the comparison and possibly even to propose validation decisions which will finally be taken or confirmed centrally.

The arrangement of the invention has the advantage of centralizing final validations, hence avoiding discrepancies due to human interventions at different sites. The high level automation further allows to significantly reduce production costs. At the same time, uniform product quality is guaranteed and production may be arranged close to the user, hence allowing for supply of fresh product.

FIG. 2 schematically represents a decentralized production site, and the description hereunder relates to a particular embodiment of such a production site, part of a production system as per the invention.

As mentioned before, a production site at a production location is a computer assisted production unit which comprises a production unit 12 and a control unit 14. The production unit 12 may consist in any type of production unit known per se, for instance an isolator or a glove box. A human operator 100 may introduce his or her hands into the gloves of the glove box 12 and carry out operation instructions for process steps as appropriate, the internal volume of the glove box being for instance under clean room conditions or other regulated or particular conditions for performance of relevant process steps. The operation of production unit 12 is computer-assisted, meaning that an associated decentralized control unit 14 controls the operations of the production unit 12. As explained before, the decentralized control unit 14 then communicates with central monitoring unit (10 in FIG. 1) for validation purposes.

The decentralized control unit 14 may comprise data storage means 111, a calculator 101, a data communication interface 104 designed to communicate (i.e. to send and optionally also receive) data with the central monitoring unit, and a communication interface 103 designed to communicate with the human operator 100. The data exchanged with the data communication interface 103 may include numerical values, such as measured parameters, as well as instructions, such as instructions to accept or refuse or repeat operations. The communication interface is designed to give instructions to the human operator, e.g. by a screen or a voice synthesis module 105 connected to a loudspeaker and/or headphones 108, and to receive reports, preferably oral reports from the human operator. To that effect, the decentralized control unit further comprises a voice recognition module 106. The voice synthesis module 105 and voice recognition module 106 are controlled by a control module 107 known in the art. The human operator bears headphones 108 and a microphone 109 cooperating with the communication interface 103 of the control unit 14.

Taking the example of determined process steps to be performed by a human operator and comprising at least a task A, the human operator interacts as follows with the decentralized control unit:
(i) instructions to perform task A are communicated by the control unit 14 to the operator 100
(ii) the operator manually carries out the task in the production unit 16; with or without particular tools or equipment
(iii) the operator reports execution of the task to the control unit
(iv) the control unit checks execution of the task.

Task A may comprise a single step or several steps.

The result of the check may be reported to the central monitoring unit 10. In a variant, reporting to the central monitoring unit 10 may occur after performance of several tasks only.

The storage means 111 comprise required software for the control of the production unit it is associated with, including instructions to perform task A. The control unit 14 comprises a communication interface 103 comprising a voice synthesis module 105, a voice recognition module 106 and a control module 107. The human operator is equipped with headphones 108 and a microphone 109 cooperating with the communication interface 103. The headphones as well as the microphone may be wireless connected to communication interface 103. In the course of (i), voice synthesis module 105 communicates instructions via headphones 108 to the human operator.

Task A is characterized by certain parameters that require to be monitored, measured, observed or applied by the manual operator. In the course of the performance of Task A (ii), the operator may be asked to report relevant parameters as appropriate. The operator's message (see (iii)) transmitted by the microphone is analyzed by the voice recognition module and translated into numerical data. Such voice recognition module advantageously incorporates a register of possible responses from the operator for individual steps or questions or instructions. For example, if the human operator has to communicate a number, the voice recognition module may only translate the message into a number. In order to further improve reliability of the system, the manual human operator may be invited to confirm the translation or interpretation of his message by the machine.

As can easily be understood, the reporting message from the human operator may simply report status of task, e.g. done, provide a numerical value or communicate an observation. Other messages, like requesting the system to repeat the task or suspend the process for a while, may also be provided for.

In the course of (iv), the message content is analyzed by the communication interface 103 (103 in cooperation with 107) and the control unit decides on the further processing. Analysis comprises notably a comparison with a preset or anticipated value or value range stored in the system.

As an example, if human operator 100 reports that the task is “done”, the control unit 14 may instruct to move to the next task through control module 107 and/or calculator 101. If human operator 100 has communicated a numerical value, further computations integrating said numerical value may be effected, including comparisons with preset values before decision is taken with respect to the next instructions to the operator, like stopping of operations if the difference with the preset value is too high or moving on to the next task.

The human operator's report may also include non-essential parameters, like expiry date of a reactant, or references of an equipment. All reported information is advantageously stored into storage means 111 and may be used later on in the validation process or report.

Voice synthesis module 105 makes use of software driven voice synthesis that is designed to generate from any text an easily and clearly understandable phonetic voice and to include signal treatment functions that translate the phonetic signal into numerical signals capable of being emitted through a loudspeaker and/or headphones. Voice recognition module 6 includes reverse functions, thus designed to transform a sound recorded by a microphone into a numerical text. Such modules are already known in the art and are used for transforming screen displayed data into voice audible by blind people.

These modules may further be coupled with translation modules such that the human operator may chose his language of preference, depending on his/her location. Such a feature may be particularly useful in the case of different production units located in different countries.

In some applications, the control unit may advantageously include a draft assistance module which assists in the drafting of instructions. It may propose predrafted tasks or steps in which relevant parameters may be modified as appropriate. Such an arrangement limits the possibilities of expressing certain instructions, but by the same token reduces the risk of interpretation errors. It further assists the drafter to remain within the imposed guidelines and/or regulations.

In other applications, the instructions are stored centrally in the central monitoring and may be amended and/or updated centrally only, in order to ensure consistent approach at all production sites. In such instance, the central monitoring unit may include a draft assistance module which assists in the drafting of instructions, preferably pre-established instructions. It may propose predrafted tasks or steps in which relevant parameters may be modified as appropriate.

It is well understood that the control by the system is not limited to the operations described herein. Other regulated operations, such as opening of the isolator, decontamination thereof, and control of technical parameters of the isolator or containment system.

The system of the invention may further be equipped with cameras designed to provide to the on-site control unit and/or to the central monitoring unit a visual follow-up of ongoing operations on respective production sites. Cameras and/or microphones installed close to the central monitoring unit may then allow for communication, including video and/or voice, between the operator at the production site and an operator at the central monitoring unit.

The above is illustrated hereunder by way of an example of a cell seeding application. A cell seeding process to be carried out under clean room and/or laminar flow conditions is saved in storing means 111 of control unit 14 A human operator 100 equipped in accordance with the guidelines associated with the relevant production room has gathered the necessary equipment for performance of the process.

When ready, the operator initiates the start of the process, for instance by pronouncing “ready”

The following dialog may then take place between the control unit (CU) and the human operator (OP):

CU: “Step 1: What's your name?”

OP: “Mister X” (this information may be used to verify whether the operator has all required authorizations to proceed)

CU: “Step 2: enter code of laminar flow used for operations”

OP: “1256” (this number may be associated with maintenance status)

CU: “enter code of temperature gauge used for operations”

OP: “1724”

CU: “Step 3: prepare beaker of 100 ml human serum. Measure beaker temperature with temperature gauge and enter temperature value”

OP: “37”

CU: “Step 4: transfer flasks T175 under laminar flow. Control 1: how many flasks have you transferred?”

OP: “2”

The number of flasks may affect the remaining instructions, such as the centrifuge parameters.

CU: “Transfer cell suspension of each flask T175 into a 500 ml tube, thereby using a 50 ml pipette. Confirm when done.”

OP: “Done”

CU: “Step 5: set centrifuge as follows: acceleration 1600 g, temperature 20° C., time 10 min. Place cell containing tubes in centrifuge receptacle and start centrifugation. Confirm when done.”

OP: “Done”

CU: “Step 6: transfer 30 microliters of suspension by means of 200 microliter pipette into 1.5 ml cell containing tube and 30 microliters of suspension into empty tube. To each tube add 30 microliters PBS and 60 microliters “Trypan blue”. Mix well and introduce 20 microliters of each dilution into receptacle of the Neubauer chamber. Start counting process. How many cells have been counted?”

OP: “1732”

The control unit 14, either through its module 107 and/or calculator 101, corrects the value of 1732 by means of the dilution coefficients used and possibly the parameters associated with the equipment used and compares the obtained result with target values for this determination. If the calculated value is below the expected range of values and if in such a case the process needs to be interrupted, the following message is issued:

CU: “Control 2: the number of cells is insufficient. Step 7: eliminate the cells in waste bin. Confirm when done.”

OP: “Done.”

If the number of cells is sufficient, the instructions for step 8 (cell seeding) may be given.

CU: “Step 9: end of operation under laminar flow. Clean bench. Take environment samples corresponding to end of operations. Confirm when done.”

OP: “Done.”

The invention is illustrated hereunder by way of a further example relating to a Percoll gradient separation of a cell culture resulting from a microbiopsy, more specifically muscular biopsy. Because of the high level regulatory requirements placed upon such production steps, the instructions are imposed by the central monitoring unit and may not be amended on site. The sole option to amend recorded instructions is to act centrally at the level of the central monitoring unit. The following dialog may take place between the control unit (CU) and the human operator (OP):

CU: “Step 1: What's your name?”

OP: “Mister X” (this information may be used to verify whether the operator has all required authorizations to proceed)

CU: “Step 2: enter code of laminar flow used for operations”OP: “1256” (this number may be associated with maintenance status)

CU: “Step 3: prepare the Percoll gradient to isolate stem cells: Add 375 μl of Percoll to 2.125 ml of NaCl in a labeled centrifuge tube to prepare 2.5 ml of a 15% Percoll solution

Add 625 μl of Percoll to 1.875 ml of NaCl in a labeled centrifuge tube to prepare 2.5 ml of a 25% Percoll solution

Add 875 μl of Percoll to 1.625 ml of NaCl in a labeled centrifuge tube to prepare 2.5 ml of a 35% Percoll solution

Place slowly 2 ml of the 15% Percoll solution in the bottom of a centrifuge tube. From below, place 2 ml of the 25% Percoll solution. Repeat the previous step with 2 ml of the 35% Percoll solution

Confirm when done.

OP: “Done”

CU: “Step 4: transfer culture microplate under the LAF and proceed to trypsination. Sample 10 μl of cell suspension and transfer into counting chamber. When done, place the remaining cell suspension on the Percoll gradient. Set centrifuge to “PROGRAM 2” and during this time proceed to QC. Start counting the cells in a first large square. Repeat the previous step with a second large square. Repeat the previous step again with a third and last large square. Confirm when done”.

OP: “Done”

CU: “Step 5: Apply the formula: Average Cell Number per Square×10,000×Dilution. How many cells do you obtain?”

The result may stop the process or not (>20.000 cells needed to continue).

OP: “80.000”

As can easily be understood, the invention is not limited to application in the biological field, in clean rooms, but may find application in many different environments. As an example, the nuclear sector represents another application area, as it requires strict compliance with appropriate guidelines in order to limit operator's exposure to radioactive radiation. The quantity of radiation suffered by the operator may for instance determine the number of tasks he or she may perform, taking into account the time required to do so.

What is claimed is:

1. A multi-site production system for production of a product under regulated conditions comprising at least two production sites linked to a central monitoring unit, each production site comprising at least one production unit for production under regulated conditions and a computerized control unit designed to receive, possibly record and transfer required product and/or process parameters to the central monitoring unit designed to check for validation purposes the production process and/or product quality.

2. The multi-site production system of claim 1, wherein the central monitoring unit consists in a computerized monitoring unit designed to receive required product and/or process parameters from the computerized control units and to compare the relevant product and/or process parameters to established standards and/or rules.

3. The multi-site production system of claim 1, wherein the central monitoring unit consists in a computerized monitoring unit designed to store and send pre-established operating instructions to the production sites, preferably through the on-site control units.

4. The multi-site production system of claim 1, wherein the computerized central monitoring unit is designed to display the results of the comparison.

5. The multi-site production system of claim 1, wherein the computerized central monitoring unit is designed to propose validation decisions.

6. The multi-site production system of claim 1, wherein the production unit is a computer assisted production unit.

7. The multi-site production system of claim 1, wherein the control unit is designed (i) to give instructions in accordance with a predetermined possibly multistep manufacturing procedure to a human operator associated with the production unit, (ii) to possibly receive an oral report by the human operator on the performance of the relevant steps of the manufacturing procedure and (iii) to control the performance the relevant steps of the manufacturing procedure and/or predetermined quality parameters of the resulting product.

8. The multi-site production system of claim 1, wherein the production unit is a glove box or isolator.

9. The multi-site production system of claim 1, wherein the production units are selected from biological product manufacturing units, pharmaceutical product manufacturing units, vaccine product manufacturing units, cell therapy product manufacturing units, gene therapy product manufacturing units, food product manufacturing units, nuclear manufacturing units and micro-electronics product manufacturing units.

10. A method for multi-site production under regulated conditions comprising producing a product under regulated conditions in production sites located at at least two production locations wherein each said production is controlled by a computerized control unit designed to receive, possibly record, and transfer required product and/or process parameters to a central monitoring unit located at another location, and wherein the central monitoring unit checks for validation purposes the production process and/or product quality.
